(19) United States
(12) Patent Application Publication
(10) Pub. No.: US 2010/0317282 A1
(43) Pub. Date: Dec. 16, 2010

(54) INDOOR UNIT OF AIR CONDITIONER

(76) Inventors: Morimichi Okada, Osaka (JP); Yoshiteru Nouchi, Osaka (JP); Tetsuya Morizane, Osaka (JP)

Correspondence Address: BIRCH STEWART KOLASCH & BIRCH, PO BOX 747, FALLS CHURCH, VA, 22040-0747, US

(21) Appl. No.: 12/526,388

(22) PCT Filed: Feb. 5, 2008
(86) PCT No.: PCT/JP2008/000142

§ 371 Date: Aug. 7, 2009

(30) Foreign Application Priority Data
Feb. 9, 2007 (JP) 2007-031113

(51) Int. Cl. F25D 31/00; B23P 19/04

(52) U.S. Cl. 454/292; 29/426.1

(57) ABSTRACT

In an indoor unit (13) installed on a ceiling, a filter (41) is arranged along an upper surface of a suction grille (28). The filter (41) is attached to a transfer belt (58), and moves as pulleys (56, 57) rotate. A rotating brush (51) is in contact with the filter (41). Dust trapped on the filter (41) is removed by the rotating brush (51) as the filter (41) moves. A dust container (60) is provided below the rotating brush (51), and the dust removed from the filter (41) accumulates in the dust container (60). The dust container (60) is attached to a suction grille (28) which can be lifted/lowered. When the suction grille (28) is lowered, the dust container (60) is lowered together with the suction grille (28).

### TECHNICAL FIELD

The present invention relates to an indoor unit of an air conditioner installed on a ceiling.

### BACKGROUND ART

An indoor unit of an air conditioner installed on a ceiling has been known. For example, Patent Document 1 discloses such an indoor unit installed on a ceiling. In general, the indoor unit is provided with a filter for removing dust from sucked air. The indoor unit of Patent Document 1 has a function of removing dust trapped on a filter, thereby reducing labor of a user who cleans the filter.

Specifically, the indoor unit of Patent Document 1 includes, as a structure for removing dust on a filter, a drive unit, a rotating brush, a collecting case, and a suction device. The filter is in the shape of a disc, and traps dust contained in the air flowing into the unit through a suction grille. The filter is provided with teeth formed on the periphery of a frame thereof. The drive unit includes a gear engaged with the teeth of the frame of the filter. The rotating brush is configured to remove the dust from the filter, and is in contact with the filter at the tip thereof. The collecting case accommodates the rotating brush therein, and collects the dust removed by the rotating brush. The suction device is configured to suck and collect the dust fell in the collecting case.

In this indoor unit, the filter rotates when the drive unit is operated, and the dust adhered to the filter is removed by the rotating brush. The dust removed from the filter falls in the collecting case, and the dust in the collecting case is sucked and collected by the suction device.

Another known indoor unit of the air conditioner includes a suction grille which can be lifted/lowered, as disclosed by Patent Document 2. This indoor unit includes a filter placed on a plate-like suction grille. When the suction grille is lowered from a main body of the indoor unit installed on a ceiling, the filter is lowered together with the suction grille. Therefore, one can detach the filter without using a ladder or the like, and can easily clean the filter.

### [Patent Document 1] Published Japanese Patent Application No. 2006-71121

### [Patent Document 2] Published Japanese Patent Application No. 2004-84998

### DISCLOSURE OF THE INVENTION

### Problem that the Invention is to Solve

In the conventional indoor unit having the function of removing the dust from the filter, the dust is automatically removed from the filter, and the dust removed from the filter accumulates in the indoor unit. This does not sufficiently reduce the user's labor because the user has to remove the accumulated dust from the indoor unit at regular time intervals, though the intervals are longer than those of removing the dust by detaching and cleaning the filter. In particular, the indoor unit installed on the ceiling involves removal of the dust at high elevations, and therefore, maintenance of the indoor unit requires great labor.

From this point of view, the present invention has been developed. The present invention is directed to an indoor unit of an air conditioner having the function of removing dust from a filter member, and aims to reduce the labor required for maintenance of the indoor unit.

### Means of Solving the Problem

A first aspect of the invention is directed to an indoor unit of an air conditioner installed on a ceiling including: a casing (25) provided with an inlet (22) and an outlet (23); a filter (41) which is provided in the casing (25) and traps dust contained in air flowing through the inlet (22), the inlet (22) opening in a lower surface of the casing (25); a suction grille (28) arranged to cover the inlet (22) of the casing (25); a lifting/lowering mechanism (45) for lifting/lowering the suction grille (28); a dust removing mechanism (50) for removing dust from the filter (41); and a dust containing portion (60) for containing the dust removed from the filter (41) by the dust removing mechanism (50), wherein the dust containing portion (60) is attached to the suction grille (28), and is lifted/lowered together with the suction grille (28).

According to the first aspect of the invention, the indoor unit (13) sucks air through the inlet (22), and blows the air into the room through the outlet (23) after controlling temperature, etc. of the air. In the casing (25), the air sucked through the inlet (22) passes the filter (41), and dust contained in the air is trapped on the filter (41). While the indoor unit (13) is operating, the dust accumulates on the filter (41). The dust trapped on the filter (41) is removed by the dust removing mechanism (50) from the filter (41), and is contained in the dust containing portion (60). When the amount of the dust accumulated in the dust containing portion (60) reaches a certain level, removal of the dust from the dust containing portion (60) is required. In the indoor unit (13), the dust containing portion (60) is lifted/lowered together with the suction grille (28). That is, the dust containing portion (60) is lowered from the casing (25) installed on the ceiling to a height that a worker can reach.

In a second aspect of the invention related to the first aspect of the invention, the dust removing mechanism (50) remains contained in the casing (25) when the dust containing portion (60) is lowered together with the suction grille (28).

According to the second aspect of the invention, the dust removing mechanism (50) is formed separately from the dust containing portion (60). The dust removing mechanism (50) is always contained in the casing (25), whether the dust containing portion (60) remains contained in the casing (25) or is lowered from the casing (25).

In a third aspect of the invention related to the first or second aspect of the invention, the dust removing mechanism (50) includes a transfer mechanism (55) for moving the filter (41), and a removing member (51) which contacts the moving filter (41) to remove the dust from the filter (41).

According to the third aspect of the invention, when the dust removing mechanism (50) removes the dust from the filter (41), the transfer mechanism (55) moves the filter (41). The removing member (51) contacts the moving filter (41) to remove the dust adhered to the filter (41). The dust removed by the removing member (51) from the filter (41) accumulates in the dust containing portion (60).

In a fourth aspect of the invention related to the third aspect of the invention, the removing member (51) is configured to be lifted/lowered together with the suction grille (28).

According to the fourth aspect of the invention, when the suction grille (28) is lowered from the indoor unit (13) installed near the ceiling, not only the dust containing portion (60), but the removing member (51), is lowered together with the suction grille (28).

In a fifth aspect of the invention related to the fourth aspect of the invention, the dust removing mechanism (50) includes a drive member (52) for driving the removing member (51) to remove the dust from the filter (41), and the drive member (52) remains contained in the casing (25) when the removing member (51) is lowered together with the suction grille (28).

According to the fifth aspect of the invention, the removing member (51), being driven by the drive member (52), removes the dust from the filter (41). When the suction grille (28) is lowered, the removing member (51) is also lowered together with the suction grille (28). In lowering them, the drive member (52) is not lowered together with the suction grille (28), but remains contained in the casing (25).

In a sixth aspect of the invention related to any one of the first to fifth aspects of the invention, the dust containing portion (60) is formed separately from the suction grille (28), and is detachably attached to the suction grille (28).

According to the sixth aspect of the invention, the dust containing portion (60) and the suction grille (28) are formed separately from each other, and the dust containing portion (60) is detachable from the suction grille (28). The dust containing portion (60) is lowered, while being attached to the suction grille (28).

In a seventh aspect of the invention related to any one of the first to fifth aspects of the invention, the dust containing portion (60) is formed integrally with the suction grille (28).

According to the seventh aspect of the invention, the dust containing portion (60) is formed integrally with the suction grille (28), and they are lifted/lowered together.

In an eighth aspect of the invention related to any one of the first to seventh aspects of the invention, the filter (41) is configured to be detachable from the transfer mechanism (55), and is lowered together with the suction grille (28).

According to the eighth aspect of the invention, when the suction grille (28) is lowered from the indoor unit (13) installed near the ceiling, the filter (41) is detached from the transfer mechanism (55), and is lowered together with the suction grille (28).

### EFFECT OF THE INVENTION

According to the present invention, the dust containing portion (60) for containing the dust removed by the dust removing mechanism (50) from the filter (41) is lowered from the casing (25) to a height that the worker can reach together with the suction grille (28). This allows the worker to lower the dust containing portion (60) to a height at which the worker can easily work, and then to easily remove the dust from the dust containing portion (60). Thus, the present invention can drastically reduce the labor required for maintenance of the indoor unit (13).

According to the second aspect of the invention, the dust removing mechanism (50) of more complicated structure than the dust containing portion (60) is always contained in the casing (25). Lifting/lowering the complicated dust removing mechanism (50) together with the dust containing portion (60) complicates the structure of the lifting/lowering mechanism (45). However, according to the present invention, the dust container (60) of a simple structure can be lifted/lowered separately from the dust removing mechanism (50). Thus, the present embodiment makes it possible to lift/lower the dust containing portion (60), while avoiding complication of the structure of the indoor unit (13).

According to the third aspect of the invention, the removing member (51) of a relatively complicated structure is fixed, and the filter (41) of a relatively simple structure is moved, so that the dust on the filter (41) is removed by the removing member (51). Thus, the present invention can simplify the structure of the dust removing mechanism (50) as compared with the case of fixing the simple filter (41) and moving the complicated removing member (51).

According to the fourth aspect of the invention, the removing member (51) is lifted/lowered together with the suction grille (28). The removing member (51) is a member directly in contact with the filter (41) to which the dust is adhered. Therefore, the dust removed from the filter (41) is likely to adhere to the removing member (51). In the present invention, the removing member (51) to which the dust is likely to adhere is lowered to a height that the worker can reach together with the suction grille (28). Thus, the present invention can reduce the labor required for cleaning the removing member (51) to which the dust is likely to adhere.

According to the fifth aspect of the invention, the removing member (51) is lifted/lowered together with the suction grille (28), and the drive member (52) for driving the removing member (51) remains contained in the casing (25). Therefore, the drive member (52), cleaning of which is less necessary than the removing member (51) and the dust containing portion (60), can be kept contained in the casing (25). This makes it possible to minimize the number of members lifted/lowered together with the suction grille (28), thereby avoiding complication of the structure of the lifting/lowering mechanism (45).

According to the sixth aspect of the invention, the dust containing portion (60) is formed separately from the suction grille (28), and is detachable from the suction grille (28). Therefore, the worker can lower the dust containing portion (60) together with the suction grille (28), detach the dust containing portion (60) from the suction grille (28), and remove the dust accumulated in the dust containing portion (60). Thus, the present invention can further facilitate the removal of the dust from the dust containing portion (60), and can further reduce the labor required for maintenance of the indoor unit (13).

According to the seventh aspect of the invention, the dust containing portion (60) is formed integrally with the suction grille (28). This makes it possible to add the dust containing portion (60) to the indoor unit (13) without increasing the number of parts of the indoor unit (13), thereby suppressing increase in manufacturing cost of the indoor unit (13).

According to the eighth aspect of the invention, the filter (41) is lifted/lowered together with the suction grille (28). If the dust cannot be completely removed from the filter (41) by the dust removing mechanism (50), cleaning of the filter (41) is required. Further, if the filter (41) is broken, the filter (41) has to be detached from the indoor unit (13). In the present invention, since the filter (41) is lowered to a height that the worker can reach together with the suction grille (28), the filter (41) can easily be detached from the indoor unit (13).

### BRIEF DESCRIPTION OF THE DRAWINGS

FIG. 1 is a refrigerant circuit diagram illustrating the structure of an air conditioner of a first embodiment.

FIG. 2 is a longitudinal cross-sectional view illustrating an indoor unit of the first embodiment.

FIG. 3 is a schematic perspective view illustrating a decorative panel of the first embodiment as viewed from below.

FIG. 4 is a schematic view illustrating a major part of the indoor unit of the first embodiment.

FIG. 5 is a schematic perspective view illustrating a major part of the indoor unit of the first embodiment.

FIG. 6 is a schematic view illustrating a major part of an indoor unit of a second embodiment.

FIGS. 7(A) and 7(B) are schematic views illustrating a major part of an indoor unit of a first modified example of the other embodiment, FIG. 7(A) shows a suction grille lifted, and FIG. 7(B) shows the suction grille lowered.

FIGS. 8(A) and 8(B) are schematic views illustrating a major part of the indoor unit of the first modified example of the other embodiment, FIG. 8(A) shows a suction grille lifted, and FIG. 8(B) shows the suction grille lowered.

FIG. 9 is a schematic view illustrating a major part of an indoor unit of a second modified example of the other embodiment.

FIG. 10 is a longitudinal cross-sectional view illustrating an indoor unit of a third modified example of the other embodiment.

### DESCRIPTION OF CHARACTERS

22 Inlet
23 Outlet
25 Casing
28 Suction grille
41 Filter
45 Lifting/lowering mechanism
50 Dust removing mechanism
51 Rotating brush (removing member)
52 Brush driving motor (drive member)
55 Transfer mechanism
60 Dust container (dust containing portion)

### BEST MODE FOR CARRYING OUT THE INVENTION

Hereinafter, embodiments of the present invention will be described in detail with reference to the drawings.

### First Embodiment

A first embodiment will be described. The present embodiment is directed to an air conditioner (10) including an indoor unit (13) of the present invention. In this air conditioner (10), the indoor unit (13) is installed on a ceiling of a room. Specifically, the indoor unit (13) is hanged on a framework of a building, and is embedded in a ceiling panel (90) of the building.

### (General Structure of Air Conditioner)

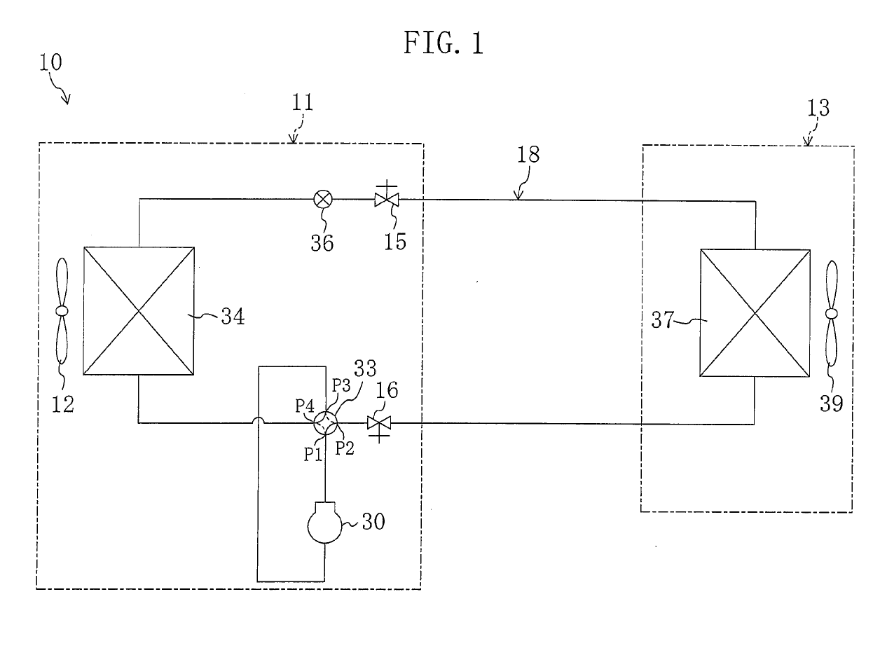

The air conditioner (10) of the present embodiment includes, as shown in FIG. 1, an outdoor unit (11) and an indoor unit (13). The outdoor unit (11) includes a compressor (30), an outdoor heat exchanger (34), an expansion valve (36), a four-way switching valve (33), and an outdoor fan (12). The indoor unit (13) includes an indoor heat exchanger (37) and an indoor fan (39).

In the outdoor unit (11), a discharge side of the compressor (30) is connected to a first port (P1) of the four-way switching valve (33). A suction side of the compressor (30) is connected to a third port (P3) of the four-way switching valve (33).

The outdoor heat exchanger (34) is configured as a cross-fin type fin-and-tube heat exchanger. One end of the outdoor heat exchanger (34) is connected to a fourth port (P4) of the four-way switching valve (33). The other end of the outdoor heat exchanger (34) is connected to a liquid stop valve (15).

The outdoor fan (12) is arranged near the outdoor heat exchanger (34). In the outdoor heat exchanger (34), outdoor air sent by the outdoor fan (12) and a circulating refrigerant exchange heat. An expansion valve (36) capable of changing the degree of opening is provided between the outdoor heat exchanger (34) and the liquid stop valve (15). A second port (P2) of the four-way switching valve (33) is connected to a gas stop valve (16).

The four-way switching valve (33) is configured to be able to switch between a first state where the first port (P1) and the second port (P2) communicate with each other, and the third port (P3) and the fourth port (P4) communicate with each other (a state indicated by a solid line in FIG. 1), and a second state where the first port (P1) and the fourth port (P4) communicate with each other, and the second port (P2) and the third port (P3) communicate with each other (a state indicated by a broken line in FIG. 1).

This air conditioner (10) selectively performs cooling operation and heating operation. In the heating operation, the four-way switching valve (33) is set to the first state. In the heating operation, a vapor compression refrigeration cycle is performed in a refrigerant circuit (18), in which the indoor heat exchanger (37) and the outdoor heat exchanger (34) function as a condenser and an evaporator, respectively. On the other hand, in the cooling operation, the four-way switching valve (33) is set to the second state. In the cooling operation, a vapor compression refrigeration cycle is performed in the refrigerant circuit (18), in which the outdoor heat exchanger (34) and the indoor heat exchanger (37) function as a condenser and an evaporator, respectively.

### (Structure of Indoor Unit)

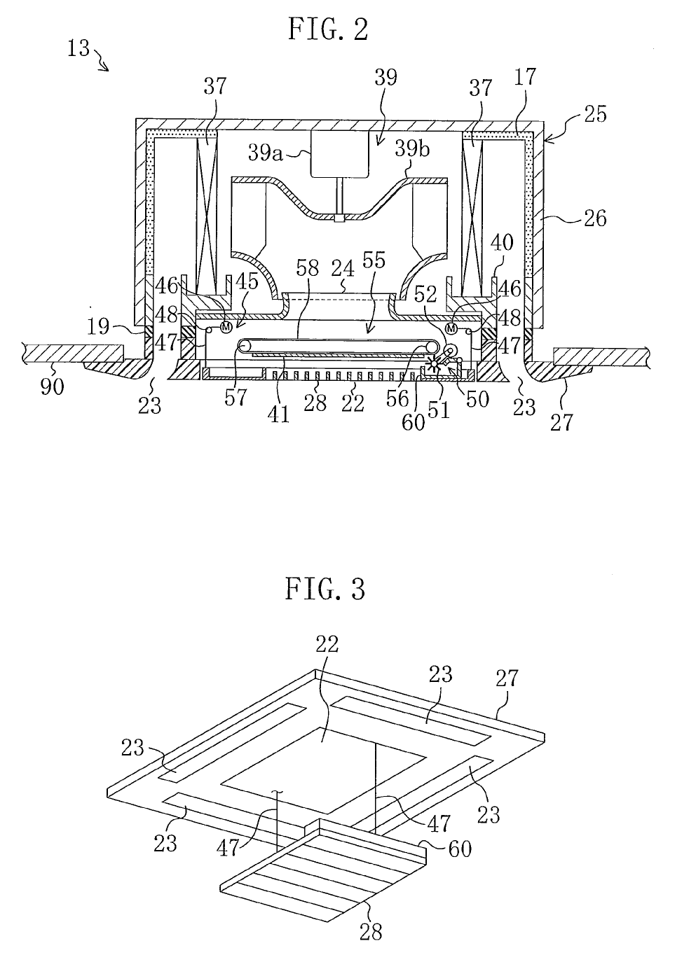

As shown in FIG. 2, the indoor unit (13) includes a casing (25) including a casing body (26) and a decorative panel (27). In the casing (25), are placed the indoor heat exchanger (37), the indoor fan (39), a drain pan (40), a filter (41), a dust removing mechanism (50), a dust container (60) as a dust containing portion, and a lifting/lowering mechanism (45).

The casing body (26) is in the shape of a substantially rectangular parallelepiped box having an open bottom. A heat insulator (17) is laminated on an inner surface of the casing body (26). The casing body (26) is arranged so that its bottom is inserted in an opening in the ceiling panel (90).

The decorative panel (27) is in the shape of a rectangular plate. When viewed in plan, the decorative panel (27) is slightly larger than the casing body (26). The decorative panel (27) is attached to the casing body (26) to cover the bottom of the casing body (26) with a sealant (19) sandwiched therebetween. The decorative panel (27) attached to the casing body (26) is exposed in the room.

As shown in FIG. 3, the decorative panel (27) is provided with one inlet (22) and four outlets (23, 23, . . . ). The inlet (22) is rectangular-shaped, and is formed in the center of the decorative panel (27). A suction grille member (28) provided with slits is fitted in the inlet (22). Each of the outlets (23) is in the shape of a narrow rectangle. The outlets (23) are formed along the sides of the decorative panel (27), respectively. That is, the outlets (23) are arranged to surround the suction grille (28) from four directions.

The indoor fan (39) is a so-called turbo fan. The indoor fan (39) is arranged near the center of the casing body (26) and above the inlet (22). The indoor fan (39) includes a fan motor (39a) and an impeller (39b). The fan motor (39a) is fixed to a top plate of the casing body (26). The impeller (39b) is connected to a rotation axis of the fan motor (39a). A bell mouth (24) communicating with the inlet (22) is provided below the indoor fan (39). The indoor fan (39) is configured to blow air sucked from below in a radial direction.

The indoor heat exchanger (37) is configured as a cross-fin type fin-and-tube heat exchanger. When viewed in plan, the indoor heat exchanger (37) is in the shape of a rectangular frame, and is arranged to surround the indoor fan (39). In the indoor heat exchanger (37), indoor air sent by the indoor fan (39) and a circulating refrigerant exchange heat.

The drain pan (40) is arranged below the indoor heat exchanger (37). The drain pan (40) receives drainage generated as a result of condensation of moisture in the air in the indoor heat exchanger (37). The drain pan (40) is provided with a drain pump (not shown) for discharging the drainage. The drain pan (40) is inclined so that the drainage is collected to part of the drain pan at which the drain pump is provided.

In the indoor unit (13) of the present embodiment, the suction grille (28) can be lifted/lowered. Specifically, the casing (25) includes a lifting/lowering mechanism (45) for lifting/lowering the suction grille (28). The lifting/lowering mechanism (45) including two lifting/lowering motors (46), two wires (47), and two lifting/lowering pulleys (48). The suction grille (28) is suspended by the two wires (47). One end of each of the wires (47) is connected to the suction grille (28). One of the wires (47) is connected to the center of one of opposing sides of the suction grille (28), and the other wire (47) is connected to the center of the other opposing side of the suction grille (28). The other ends of the wires (47) are connected to the corresponding lifting/lowering motors (46), respectively. The wires (47) are hung on the corresponding lifting/lowering pulleys (48), respectively.

In the casing (25), the filter (41), the dust removing mechanism (50), and the dust container (60) are arranged between the suction grille (28) and the bell mouth (24) (see FIG. 2). The dust removing mechanism (50) includes a rotating brush (51) as a removing member, a brush driving motor (52), and a transfer mechanism (55).

The filter (41) is a rectangular mesh sheet. The filter (41) is arranged along an upper surface of the suction grille (28) to cover the slit openings of the suction grille (28).

As shown in FIGS. 3 to 5, the transfer mechanism (55) includes two drive pulleys (56), two driven pulleys (57), two transfer belts (58), and two guide rails (54).

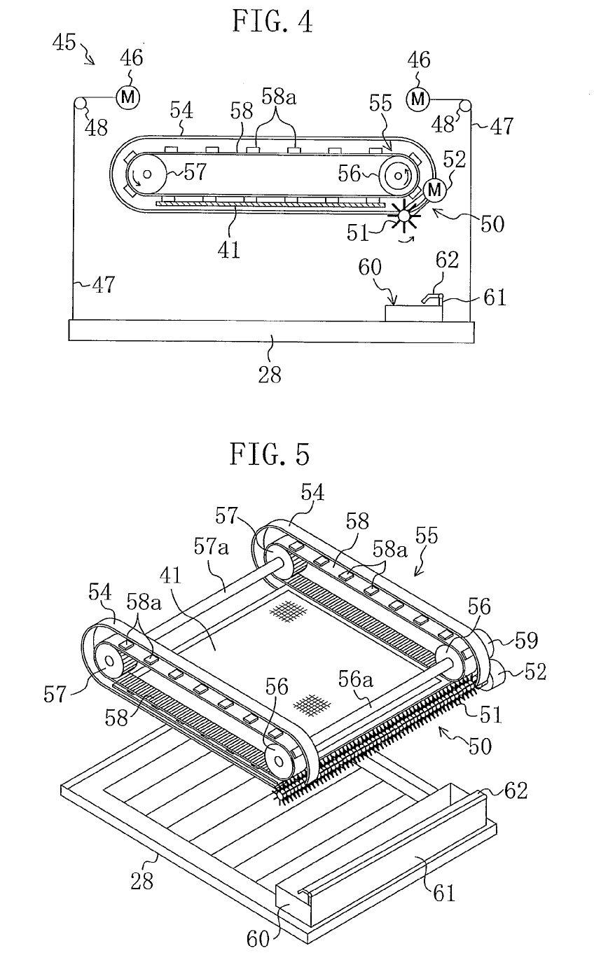

On one side of the filter (41) (on the right side in FIGS. 2 and 4), the two drive pulleys (56) are coaxially arranged so as to face each other with the filter (41) provided therebetween. The two drive pulleys (56) are connected to each other by a shaft (56a) arranged coaxially with the drive pulleys (56). The shaft (56a) is connected with a filter driving motor (59). On the other side of the filter (41) (on the left side in FIGS. 2 and 4), the two driven pulleys (57) are coaxially arranged so as to face each other with the filter (41) provided therebetween. The two driven pulleys (57) are connected to each other by a shaft (57) arranged coaxially with the driven pulleys (57).

One of the two drive belts (58) is hung on the drive pulley (56) and the driven pulley (57) on the front side in FIG. 5, and the other drive belt (58) is hung on the drive pulley (56) and the driven pulley (57) on the rear side in FIG. 5. Specifically, one of the two drive belts (58) is arranged along a side of the filter (41) on the front side in FIG. 5, and the other drive belt (58) is arranged along a side of the filter (41) on the rear side in FIG. 5. Each of the drive belts (58) is a cogged belt provided with a plurality of cogs formed on an inner circumferential surface thereof. The cogs are engaged with grooves formed on outer circumferential surfaces of the drive pulley (56) and the driven pulley (57).

Each of the drive belts (58) has a plurality of projections (58a) on a back surface (i.e., an outer circumferential surface) thereof. Each of the plurality of projections (58a) is in the shape of a rectangular parallelepiped, and they are arranged at regular intervals along the extending direction of the drive belt (58). Though not shown, a plurality of attachment holes in a shape corresponding to the projections (58a) are arranged at regular intervals on a frame portion of the filter (41) facing the transfer belts (5). The attachment holes on the frame portion of the filter (41) are arranged at almost the same intervals as the projections (58a) of the transfer belts (58). The projections (58a) of the transfer belts (58) fit in the attachment holes of the filter (41).

Each of the guide rails (54) is a strip-shaped member arranged to surround the outer surface of the transfer belt (58) hung on the drive pulley (56) and the driven pulley (57), and is in a shape of an ellipse when viewed from the side (see FIGS. 4 and 5). One guide rail (54) is provided for one transfer belt (58). As shown in FIG. 4, the frame portion of the filter (41) is sandwiched between the transfer belt (58) and the guide rail (54). In FIG. 4, a gap appears to exist between an inner circumferential surface of the guide rail (54) and the filter (41), but actually, the filter (41) is in contact with the inner circumferential surface of the guide rail (54).

The rotating brush (51) is configured of a rod-shaped base portion and bristles attached to the circumference of the base portion. A length of the rotating brush (51) is almost the same as or slightly greater than the width of the filter (41). The rotating brush (51) is arranged below the drive pulleys (56) in parallel with the shaft (56a) connecting the drive pulleys (56). The rotating brush (51) can contact the filter (41) from below. The rotating brush (51) is connected to a brush driving motor (52) as a drive member, and is driven to rotate by the brush driving motor (52).

The dust container (60) is a container member in the shape of a narrow rectangular parallelepiped, and is placed on the suction grille (28). The dust container (60) is arranged along the side of the suction grille (28) to which the wire (47) of the lifting/lowering mechanism (45) is attached. The dust container (60) is detachable from the suction grille (28). The dust container (60) is arranged so that a longitudinal direction thereof is substantially parallel to the axial direction of the rotating brush (51).

In the dust container (60), as shown in FIGS. 4 and 5, one of longitudinal side surfaces (61) extending in the longitudinal direction is taller than the other. To a top end of the taller longitudinal side surface (61), a narrow top surface portion (62) extending in the longitudinal direction of the longitudinal side surface (61) is rotatably attached. A distal end (a left end in FIG. 4) of the top surface portion (62) is bent downward. The top surface portion (62) covers almost half of the top of the dust container (60), and the other half is left open. In the state where the suction grille (28) is at the uppermost position (the position shown in FIG. 2), the rotating brush (51) enters the top opening of the dust container (60), i.e., the dust container (60) covers the rotating brush (51) from below.

Though not shown, the indoor unit (13) of the present embodiment is provided with a detection sensor for detecting the amount of the dust in the dust container (60). For example, the detection sensor measures tension of the wires (47), and estimates the weight of the dust container (43) from the measured tension. The weight of the dust container (60) increases as the amount of the dust in the dust container (60) increases. Therefore, the indoor unit (13) is configured to display, for example, on a remote controller, that the dust container (60) requires cleaning, when the weight of the dust container (60) detected by the detection sensor reaches or exceeds a predetermined value.

### —Working Mechanism of Indoor Unit—

In the cooling or heating operation, indoor air is sucked into the casing (25) of the indoor unit (13) through the inlet (22). When the indoor air passes through the filter (41), dust contained in the indoor air, such as cotton dust, is trapped on the filter (41). The air cleaned by the filter (41) is blown in the radial direction by the impeller (39b) of the indoor fan (39), and passes the indoor heat exchanger (37) to exchange heat with the refrigerant. The air heated or cooled in the indoor heat exchanger (37) is supplied to the room through the outlets (23).

In the cooling or heating operation, the filter (41) traps the dust contained in the air sucked into the indoor unit (13) through the inlet (22). As the amount of the dust trapped on the filter (41) increases, resistance to the air passing the filter (41) increases, thereby decreasing the amount of air passing through the indoor unit (13). Therefore, the indoor unit (13) performs dust removal operation while the cooling and heating operations are stopped. For example, when total operating time from the previous removal operation reaches a predetermined length, the indoor unit (13) performs the dust removal operation after the cooling or heating operation is stopped.

In the dust removal operation, the brush driving motor (52) rotates the rotating brush (51). The rotating brush (51) rotates in a counterclockwise direction in FIGS. 2 and 4. In the dust removal operation, the filter driving motor (59) rotates the drive pulleys (56). The drive pulleys (56) rotate in a counterclockwise direction in FIGS. 2 and 4. As the drive pulleys (56) rotate, the filter (41) engaged with the projections (58a) of the transfer belts (58) is guided by the guide rails (54), and moves to the right in FIGS. 2 and 4. At this time, the filter (41) moves in contact with the rotating brush (51).

The dust adhered to the filter (41) is removed by the bristles of the rotating brush (51), and falls into the dust container (60) below the rotating brush (51). Some of the dust removed from the filter (41) adheres to the rotating brush (51). The dust adhered to the rotating brush (51) is removed as the rotating brush (51) strikes a distal end of the top surface portion (62) of the dust container (60). The dust removed from the rotating brush (51) also accumulates in the dust container (60).

The rotating brush (51) stops after every part of the filter (41) passes above the rotating brush (51). Then, when the filter (41) returns to the position below the pulleys (56, 57), the drive pulleys (56) stop.

As described above, when the amount of the dust in the indoor unit (13) reaches a certain level, the indoor unit (13) of the present embodiment displays on a remote controller or the like that the dust container (60) requires cleaning. Then, when a worker who noticed the display inputs a predetermined command with the remote controller, the lifting/lowering motors (46) rotate to unwind the wires (47), thereby lowering the suction grille (28). When the suction grille (28) is lowered to a height that the worker can reach, the worker detaches the dust container (60) from the suction grille (28), and removes the dust from the dust container (60) and disposes it. Then, the worker attaches the dust container (60) to the suction grille (28), and inputs a command to lift the suction grille (28) with the remote controller. In response to the input, the lifting/lowering motors (46) rotate to wind the wires (47), thereby lifting the suction grille (28). The lifting/lowering motors (46) stop when the suction grille (28) returns to the casing (25).

### Advantages of First Embodiment

In the present embodiment, the dust container (60) for containing the dust removed by the dust removing mechanism (50) from the filter (41) is lowered together with the suction grille (28) from the casing (25) to a height that the worker can reach. This allows the worker to lower the dust container (60) to a height at which the worker can easily work, and then to easily remove the dust from the dust container (60). Thus, the present embodiment can drastically reduce the labor required for maintenance of the indoor unit (13).

In the present embodiment, the dust removing mechanism (50) of more complicated structure than the dust container (60) is always contained in the casing (25). Lifting/lowering the complicated dust removing mechanism (50) together with the dust container (60) complicates the structure of the lifting/lowering mechanism (45). However, according to the present embodiment, the dust container (60) of a simple structure can be lifted/lowered separately from the dust removing mechanism (50). Thus, the present embodiment makes it possible to lift/lower the dust container (60), while avoiding complication of the structure of the indoor unit (13).

In the present embodiment, the dust is removed from every part of the filter (41) by moving the filter (41) relative to the fixed rotating brush (51). Although it is possible to fix the filter (41) and move the rotating brush (51), this involves moving the dust container (60) together with the rotating brush (51). However, according to the present embodiment, the rotating brush (51) is not displaced, and therefore, the dust container dust container (60) is not displaced, either. Thus, the present embodiment can avoid complication of the structure of the indoor unit (13) as compared with the case of fixing the filter (41) and moving the rotating brush (51).

In the present embodiment, the dust container (60) is formed separately from the suction grille (28), and is detachable from the suction grille (28). Therefore, the worker can lower the dust container (60) together with the suction grille (28), detach the dust container (60) from the suction grille (28), and then remove the dust accumulated in the dust container (60). Thus, the present embodiment can further facilitate the removal of the dust from the dust container (60), and can further reduce the labor required for maintenance of the indoor unit (13).

### Second Embodiment

A second embodiment will be described. An indoor unit (13) of the present embodiment is configured by changing the structure of the transfer mechanism (55) of the indoor unit of the first embodiment.

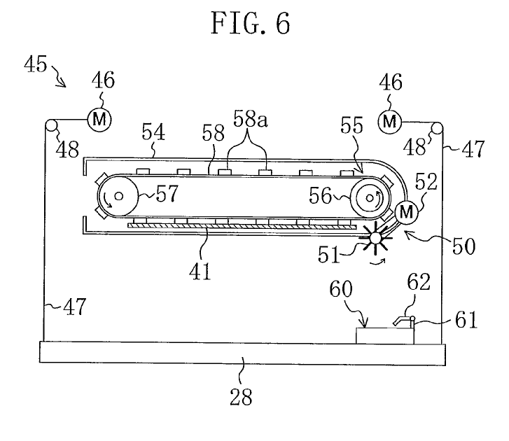

As shown in FIG. 6, the transfer mechanism (55) of the present embodiment is different from that of the first embodiment in the shape of the guide rails (54). Specifically, each of the guide rails (54) of the present embodiment is rotated U-shaped when viewed from the side, with an opening thereof positioned near the driven pulleys (57). End portions of the guide rails (54) near the opening are bent inside at a right angle. The filter driving motor (59) of the transfer mechanism (55) of the present embodiment can rotate in a reverse direction.

In FIG. 6, a gap appears to exist between the inner circumferential surface of the guide rail (54) and the filter (41), but actually, the filter (41) is in contact with the inner circumferential surface of the guide rail (54).

In the transfer mechanism (55) of the present embodiment, the filter (41) does not move only in a single direction as described in the first embodiment, but it reciprocates.

Specifically, in removing the dust from the filter (41) with the rotating brush (51), the drive pulleys (56) rotate in a counterclockwise direction in FIG. 6, and the filter (41) moves to the right in FIG. 6. Once every part of the filter (41) moves above the drive pulleys (56) and the driven pulleys (57), the drive pulleys (56) rotates in a reverse direction, i.e., a clockwise direction in FIG. 6, and the filter (41) returns to the original position (i.e., the position below the drive pulleys (56) and the driven pulleys (57)). While the pulleys reciprocate, the rotating brush (51) may keep or stop rotating.

### Other Embodiments

### First Modified Example

As a modification to the above-described embodiments, the filter (41) may be lifted/lowered together with the suction grille (28).

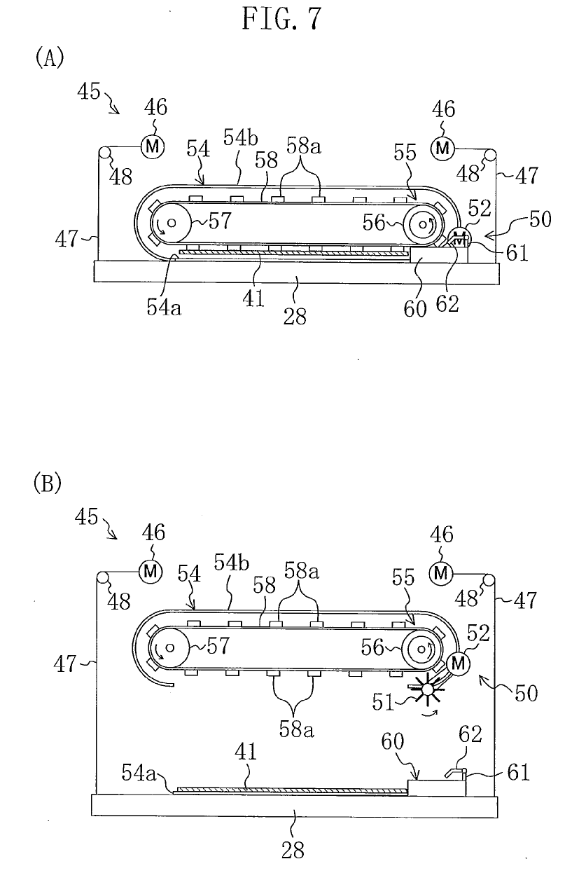

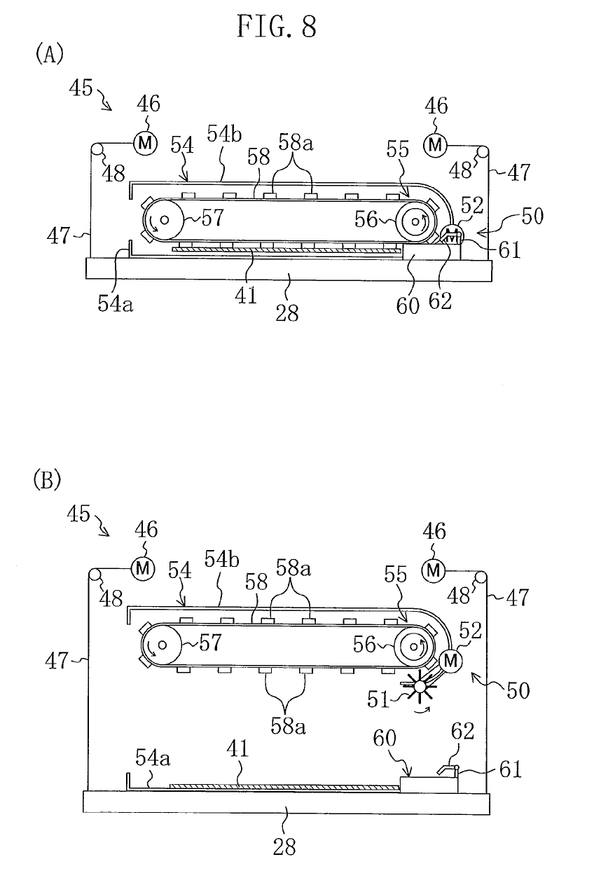

This modified example will be described with reference to FIGS. 7(A), 7(B), 8(A), and 8(B). FIGS. 7(A) and 7(B) show the first modified example of the indoor unit (13) of the first embodiment. FIGS. 8(A) and 8(B) show the first modified example of the indoor unit (13) of the second embodiment.

As shown in FIGS. 7(A), 7(B), 8(A), and 8(B), in the first modified example of the indoor unit (13), each of the guide rails (54) is divided into a first portion (54a), which is a linearly extending lower portion, and a second portion (54b), which is a remaining portion of the guide rail. The first portion (54a) of the guide rail (54) is attached to the suction grille (28). In FIGS. 7(A) and 8(A), a gap appears to exist between the inner circumferential surface of the guide rail (54) and the filter (41), but actually, the filter (41) is in contact with the inner circumferential surface of the guide rail (54).

As shown in FIGS. 7(B) and 8(B), when the suction grille (28) is lowered from the indoor unit (13), the first portions (54a) of the guide rails (54) are also lowered together with the suction grille (28). In this case, the filter (41) is detached from the projections (58a) of the transfer belts (58), is placed on the first portions (54a) of the guide rails (54), and is lowered together with the suction grille (28). Further, when the suction grille (28) is lifted and fitted in the main body of the decorative panel (27), the projections (58a) of the transfer belts (58) are fitted in the attachment holes of the filter (41). In this way, the filter (41) is detached from/attached to the transfer belts (58) of the transfer mechanism (55) as the suction grille (28) is lowered/lifted.

### Second Modified Example

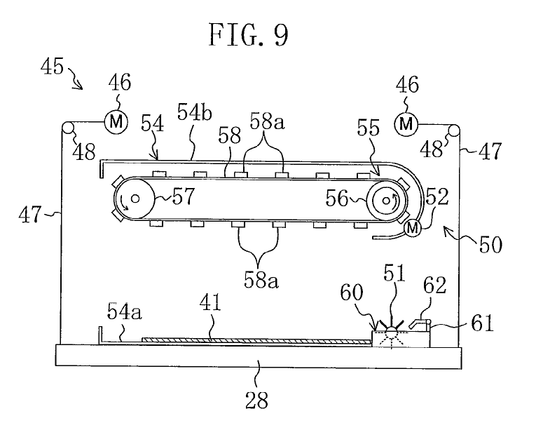

As a modification to the embodiments and the first modified example described above, the rotating brush (51) may be lifted/lowered together with the suction grille (28) as shown in FIG. 9. FIG. 9 shows the second modified example of the first modified example of the second embodiment (see FIG. 8).

In the second modified example, the rotating brush (51) is attached to the dust container (60). Though not shown, the rotating brush (51) of this modified example is engaged with the brush driving motor (52) through a gear. Specifically, a gear coaxial with the rotating brush (51) and a gear attached to an output shaft of the brush driving motor (52) are engaged with each other, and the engaged gears transfer rotation power from the brush driving motor (52) to the rotating brush (51). When the suction grille (28) is lowered from the indoor unit (13), the gear of the rotating brush (51) and the gear of the brush driving motor (52) are disengaged, and the rotating brush (51) is lowered together with the suction grille (28) and the dust container (60).

### Third Modified Example

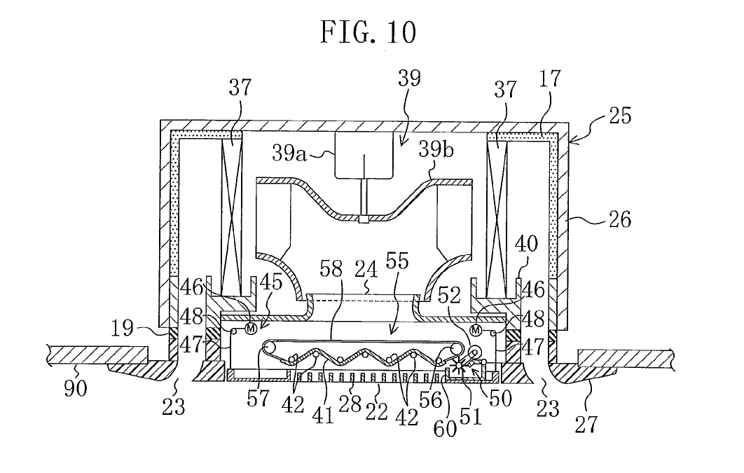

As a modification to the embodiments and the modified examples described above, rod-shaped guide rollers (42) extending vertically to the sheet of FIG. 10 may be arranged above and below the filter (41) so that the filter (41) is supported in the corrugated shape during the heating and cooling operations. In this modified example, an area of the filter (41) can be increased as compared with that of the filter (41) supported in the flat shape (see FIG. 2). This reduces an average flow rate of air passing through the filter (41), thereby reducing pressure loss of the air passing through the filter (41).

### Fourth Modified Example

As a modification of the embodiments and the modified examples described above, either one of the brush driving motor (52) for rotating the rotating brush (51) and the filter driving motor (59) for rotating the drive pulleys (56) may be omitted. When the brush driving motor (52) is omitted, the rotating brush (51) can be rotated by contact with the filter (41) which moves as the filter driving motor (59) rotates. On the other hand, when the filter driving motor (59) is omitted, the filter (41) can be moved in response to the rotation of the rotating brush (51) in contact with the filter (41).

### Fifth Modified Example

As a modification of the embodiments and the modified examples described above, the dust container (60) may be integrated with the suction grille (28). In this case, the suction grille (28) is provided with flat walls standing on a top surface thereof to surround a portion of the top surface, and the portion surrounded by the walls functions as the dust container. This can provide the dust container without increasing the number of parts of the indoor unit (13), thereby suppressing increase of manufacturing cost of the indoor unit (13).

### Sixth Modified Example

When the filter (41) remains contained in the casing (25) as described in the first and second embodiments, the filter (41) may be integrated with the transfer belts (58).

### Other Modified Examples

As a modification to the above-described embodiments, the dust removing mechanism (50) may be configured to remove the dust from the filter (41) by sucking the dust.

As a modification to the above-described embodiments, the indoor unit (13) may be configured to include an inlet (22) formed in a top plate or a sidewall of the casing (25).

The above embodiments are merely described as preferred embodiments in nature, and do not intend to limit the scope, applications and use of the invention.

### INDUSTRIAL APPLICABILITY

As described above, the present invention is useful for an indoor unit of an air conditioner.

1. An indoor unit of an air conditioner installed on a ceiling comprising:
a casing (25) provided with an inlet (22) and an outlet (23);
a filter (41) which is provided in the casing (25) and traps dust contained in air flowing through the inlet (22), the inlet (22) opening in a lower surface of the casing (25);
a suction grille (28) arranged to cover the inlet (22) of the casing (25);
a lifting/lowering mechanism (45) for lifting/lowering the suction grille (28);
a dust removing mechanism (50) for removing dust from the filter (41); and
a dust containing portion (60) for containing the dust removed from the filter (41) by the dust removing mechanism (50), wherein
the dust containing portion (60) is attached to the suction grille (28), and is lifted/lowered together with the suction grille (28).

2. The indoor unit of the air conditioner of claim 1, wherein
the dust removing mechanism (50) remains contained in the casing (25) when the dust containing portion (60) is lowered together with the suction grille (28).

3. The indoor unit of the air conditioner of claim 1, wherein
the dust removing mechanism (50) includes a transfer mechanism (55) for moving the filter (41), and a removing member (51) which contacts the moving filter (41) to remove the dust from the filter (41).

4. The indoor unit of the air conditioner of claim 3, wherein
the removing member (51) is configured to be lifted/lowered together with the suction grille (28).

5. The indoor unit of the air conditioner of claim 4, wherein
the dust removing mechanism (50) includes a drive member (52) for driving the removing member (51) to remove the dust from the filter (41), and
the drive member (52) remains contained in the casing (25) when the removing member (51) is lowered together with the suction grille (28).

6. The indoor unit of the air conditioner of any one of claims 1 to 5, wherein
the dust containing portion (60) is formed separately from the suction grille (28), and is detachably attached to the suction grille (28).

7. The indoor unit of the air conditioner of any one of claims 1 to 5, wherein
the dust containing portion (60) is formed integrally with the suction grille (28).

8. The indoor unit of the air conditioner of claim 1, wherein
the filter (41) is configured to be detachable from the transfer mechanism (55), and is lowered together with the suction grille (28).
